(19) United States
(12) Patent Application Publication
(10) Pub. No.: US 2015/0206090 A1
(43) Pub. Date: Jul. 23, 2015

(54) METHODS AND SYSTEMS FOR DETERMINING A FATIGUE LEVEL OF AN OPERATOR

(71) Applicant: ABBYY Development LLC, Moscow (RU)

(72) Inventors: Aram Bengurovich Pakhchanyan, Moscow (RU); Elena Leonardovna Korotkova, Moscow (RU)

(21) Appl. No.: 14/508,332

(22) Filed: Oct. 7, 2014

(30) Foreign Application Priority Data
Jan. 21, 2014 (RU) 2014101664

(51) Int. Cl. G06Q 10/06; G06F 3/01

(52) U.S. Cl. CPC G06Q 10/06398; G06F 3/013

(57) ABSTRACT

A method for detecting a fatigue level of an operator includes monitoring an activity level of an operator in a first mode. The method also includes detecting a change in the activity level of the operator in the first mode. The method further includes switching to a second mode from the first mode, in response to detecting the change in the activity level of the operator.

### CROSS REFERENCE TO RELATED APPLICATIONS

This application claims the benefit of priority under 35 USC 119 to Russian Patent Application No. 2014101664, filed Jan. 21, 2014; the disclosure of which is incorporated herein by reference.

### FIELD OF TECHNOLOGY

The subject matter of the present application relates to the field verification of any type of data, specifically to control and improve the quality of an operator's work.

### BACKGROUND

Operators can be assigned to perform various tasks or any monotonous work and can become fatigued while performing these tasks. When an operator becomes fatigued, the quality of their work can be reduced, resulting in errors and mistakes.

### SUMMARY

In one aspect, the present disclosure is related to a method for detecting a fatigue level of an operator. The method includes monitoring an activity level of an operator in a first mode, detecting a change in the activity level of the operator in the first mode, and switching to a second mode from the first mode, in response to detecting the change in the activity level of the operator. The method further includes monitoring a parameter of the activity level during a time period in the beginning of the operator's work, calculating a mean value of the parameter for the time period, determining a threshold value based at least in part on the mean parameter value, and comparing new values of the monitored parameter with the threshold value. The method further includes monitoring eye movement of the operator. The method further includes recording a length of gaze on some fixed points during a period of time, calculating an average length of gaze for the time period and comparing the average length of gaze on fixed points to a previous length of gaze value and/or a threshold value. The method further includes tracking an interval between eye movement from a first fixed point to a second fixed point and comparing the interval to a previous value. The method further includes tracking a frequency of keystrokes or touch inputs.

In some implementations, the method further includes calculating a mean rate for a cursor, recording a speed of the cursor controlled by an operator, and comparing the speed of the cursor to the mean rate. The method further includes calculating a mean time for the cursor remaining still, determining an amount of time the cursor remains still, and comparing the amount of time the cursor remains still to the mean time. In some implementations, the method further includes recording a number of self-corrections made by the operator. The method further includes assigning a first task to the operator, assigning a second task to a second operator, and comparing the first task completed by the operator to the second task completed by the second operator. The method further includes assigning a control task to the operator, and comparing the completed control task to a correct version of performing the control tasks. The method further includes switching to a second mode that includes easier tasks for the operator.

In another aspect, the present disclosure is related to a system to detect a fatigue level of an operator. The system includes a memory configured to store processor-executable instructions and a processor operatively coupled to the memory. The processor is configured to monitor an activity level of an operator in a first mode, detect a change in the activity level of the operator in the first mode, and switch to a second mode from the first mode, in response to detecting the change in the activity level of the operator. In some implementations, the system includes a camera. The processor is further configured to monitor a parameter of the activity level during a time period in the beginning of the operator's work, calculate a mean value of the parameter for the time period, determine a threshold value based at least in part on the mean parameter value, and compare new values of the monitored parameter with the threshold value. The processor is further configured to monitor eye movement of the operator. The processor is further configured to record a length of gaze some fixed points during a time period, calculate an average length of gaze for the time period, and compare the average length of gaze on fixed points to a previous length of gaze value and/or a threshold value. The processor is further configured to track an interval between eye movement from a first fixed point to a second fixed point, and compare the interval to a previous value. The processor is further configured to track a frequency of keystrokes or touch inputs.

In some implementations, the processor is further configured to calculate a mean rate for the cursor, record a speed of the cursor controlled by an operator, and compare the speed of the cursor to the mean rate. The processor is further configured to calculate a mean time for the cursor remaining still, determine an amount of time the cursor remains still, and compare the amount of time the cursor remains still to the mean time. The processor is further configured to record a number of self-corrections made by the operator. The processor is further configured to assign a first task to the operator, assign a second task to a second operator, and compare the first task completed by the operator to the second task completed by the second operator. The processor is further configured to assign a control task to the operator and compare the completed control task to a correct version of performing the control tasks. The processor is further configured to switch to a mode with easier tasks for the operator.

In another aspect, the present disclosure is related to a non-transitory computer-readable storage medium having computer-readable instructions stored therein, the instructions being executable by a processor of a computing system. The instructions include instructions to monitor an activity level of an operator in a first mode, instructions to detect a change in the activity level of the operator in the first mode, and instructions to switch to a second mode from the first mode, in response to detecting the change in the activity level of the operator. The instructions further include instructions to monitor a parameter of the activity level during a time period in the beginning of the operator's work, instructions to calculate a mean value of the parameter for the time period, instructions to determine a threshold value based at least in part on the mean parameter value, and instructions to compare new values of the monitored parameter with the threshold value. The instructions further include instructions to monitor eye movement of the operator. The instructions further include instructions to record a length of gaze on some fixed points during a time period, calculate an average length of gaze for the time period, and instructions to compare the average length of gaze on fixed points to a previous length of gaze value. The instructions further include instructions to track an interval between eye movement from a first fixed point to a second fixed point, and instructions to compare the interval to a previous value. The instructions further include instructions to track a frequency of keystrokes or touch inputs.

In some implementations, the instructions further include instructions to calculate a mean rate for the cursor, instructions to record a speed of the cursor controlled by an operator, and instructions to compare the speed of the cursor to the mean rate. The instructions further include instructions to calculate a mean time for the cursor remaining still, instructions determine an amount of time the cursor remains still, and instructions to compare the amount of time the cursor remains still to the mean time. The instructions further include instructions to record a number of self-corrections made by the operator. The instructions further include instructions to assign a first task to the operator, instructions to assign a second task to a second operator, and instructions to compare the first task completed by the operator to the second task completed by the second operator. The instructions further include instructions to assign a control task to the operator and instructions to compare the completed control task to a correct version of performing the control tasks. The instructors further include instructions to switch to a mode with easier tasks for the operator.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is flow diagram of a method of implementation for detecting a fatigue level of an operator in accordance with an illustrative embodiment;

FIG. 2 is a flow diagram of a method implementation for monitoring an activity level of an operator in accordance with an illustrative embodiment;

FIG. 3 illustrates an example of a task to verify recognized characters in a document image in accordance with an illustrative embodiment;

FIG. 4 illustrates an example of group verification in accordance with an illustrative embodiment;

FIG. 5 illustrates an example of group verification of checkmarks in accordance with an illustrative embodiment; and

FIG. 6 illustrates an example of a system for detecting a fatigue level of an operator in accordance with an illustrative embodiment.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one implementation” or “an implementation” means that a particular feature, structure, or characteristic described in connection with the implementation is included in at least one implementation of the invention. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not other implementations.

The subject matter of the present disclosure makes it possible to determine operator fatigue and to take appropriate steps to improve the quality of the work performed by the operator. The methods described can be used to monitor an operator's activity. If operator fatigue is detected, the system can transfer the working application to a special mode that includes simpler operations. Fatigue is generally understood to result in a reduction of the operator's performance.

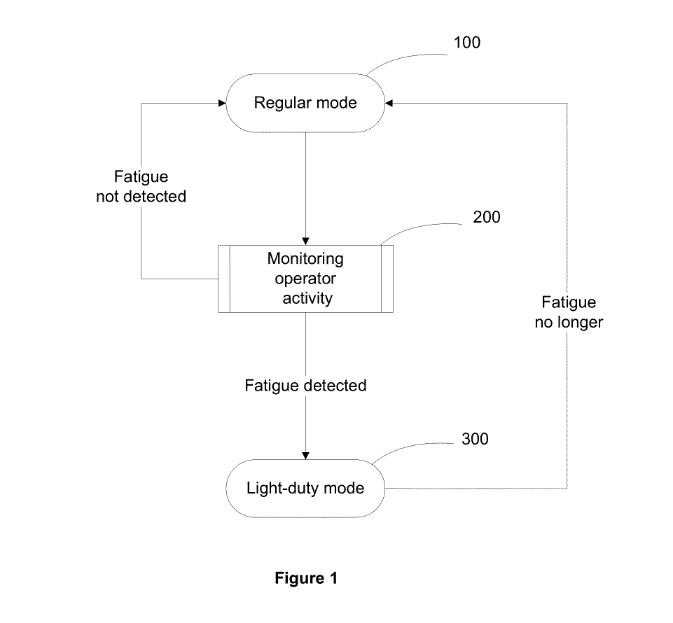

FIG. 1 shows a flow diagram of a method of implementation for detecting a fatigue level of an operator. The method may be implemented on a computing device (e.g., a user device). In one implementation, the method is encoded on a computer readable medium that contains instructions that, when executed by the computing device, cause the computing device to perform operations of the method. The method as described in FIG. 1 for example may be used to detect a fatigue level of the operator during the task of verifying recognized characters in a document image or a batch of document images.

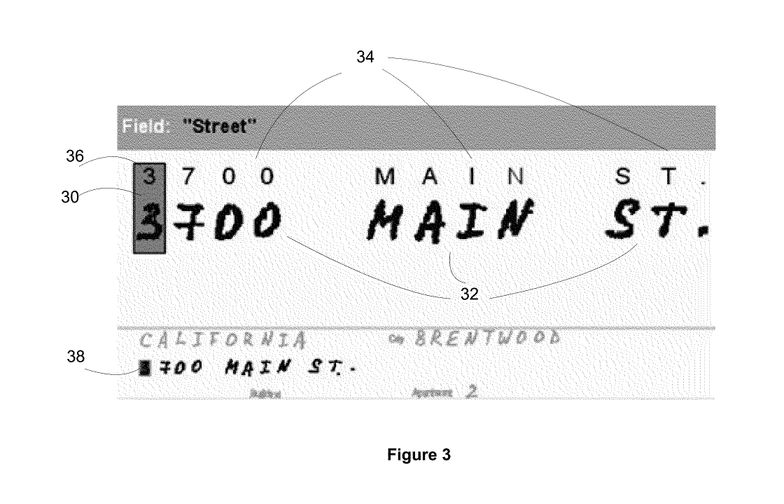

In some implementations, the operator may be verifying recognized characters or symbols in document images, for example the characters and symbols as illustrated in FIGS. 3-5. The characters to be recognized may include, without limitation, digits, letters, checkmarks, and/or symbols.

At block 100, the system is in a regular mode. In some implementations, the regular mode may be referred to as the normal mode. In an implementation, the regular mode may be the initial setting. In other implementations, the system may be initially in a light-duty mode and may switch to the regular mode. The light-duty mode may also be referred to as a simple mode. In some implementations, when the system is in the light-duty mode, the system may request that the operator perform simpler tasks than those performed in the regular mode.

At block 200, the system is monitoring an operator, operator's actions, or operator's state. In some implementations, the operator may be constantly monitored. In other implementations, the operator may be monitored for a pre-determined amount of time or a random amount of time. The operator may be monitored to detect a level of fatigue of the operator and/or an activity level of the operator. In some implementations, the operator may be performing a task in a first mode while being monitored. In one implementation, the task may be to verify results of character recognition in document images. In some implementations, if no level of fatigue is detected in the operator and/or if the activity level of the operator has not changed, the system may stay in regular mode. In other implementations, if a level of fatigue is detected in the operator and/or the activity level of the operator changes, the system may switch from the first mode to a second mode. In some implementations, the first mode may be the regular mode and the second mode may be the light-duty mode. In other implementations, the first mode may be the light-duty mode and the second mode may be the regular mode.

At block 300, the system switches from a regular mode to a light-duty mode (300). In some implementations, the system may switch modes in response to detecting a change in an activity level of the operator. In an implementation, a change in the activity level of an operator may correspond to a level of fatigue of the operator. In one implementation, the system may switch modes when the activity level of the operator goes below a threshold value. In some implementations, in light-duty mode, various work scenarios can be proposed to the operator, for example providing simpler tasks for the operator to work on. In an implementation, providing simpler tasks may include grouping tasks that require the same and/or a similar response from the operator. For example and without limitation, grouping similar tasks may include grouping all tasks that require a yes/no response. This may be done to prevent and/or limit the mistakes that the operator might make in a fatigued state. In some implementations, if the activity level of the operator increases after a certain amount of time has passed, the working application may switch from light-duty mode to regular mode. In an implementation, the system may change from light-duty to regular mode if the activity level of the operator rises above the threshold value.

In some implementations, the most efficient way to define a threshold value is to adjust it personally for each operator, because each person has different abilities, qualifications and work rhythms. For this purpose, the system can record some observed parameters of the activity level of an operator in the beginning of his/her work. Further, the system can monitor the operator and use these initial values to estimate operator's fatigue. The value of any monitored activity parameter can be compared with its initial value to detect a decrease in the activity level of the operator. The threshold value can be defined as a portion or a percentage of the initial value of any activity parameter. In some implementations, an administrator can modify which portion or percentage of the initial value is to be considered as the threshold value. In other implementations, a default value may be used. For example, if monitored value decreases twice (or in another example of settings decreases by 40 percent) compared to the initial value, then the system may switch to light-duty mode. In some implementations a different threshold value for return switching (from light-duty mode to regular mode) may be used. E.g., if monitored value increases to ⅔ (or in another example of settings to 75 percent) of the initial value, the activity level of the operator may be considered as restored and the system may change from light-duty to regular mode.

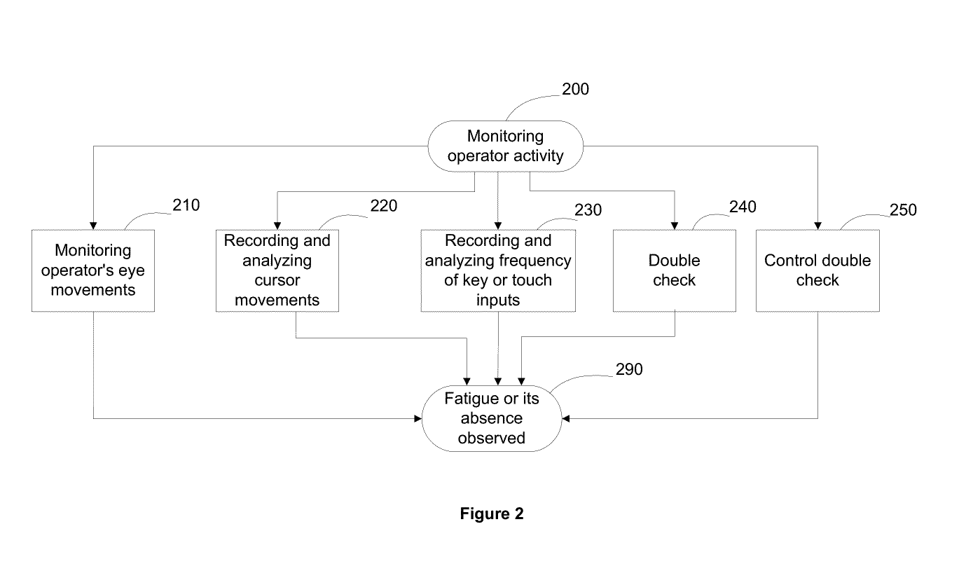

FIG. 2 shows a flow diagram of a method for monitoring an activity or fatigue level of an operator. Operator fatigue may be determined in several ways, for example at block 210, the movement of the operator's eyes are monitored. In an implementation, a camera may be installed opposite the operator to detect the eye movement of the operator. In some implementations, the system may record a length of an operator's gaze on a fixed point. The system may also calculate and record the intervals at which the operator's gaze moves from one part of the monitor to another fixed point. In some implementations, the fixed points may be on a workstation screen or a monitor, such as a computer monitor. In other implementations, one fixed point may be on a monitor and a second fixed point may be external to the monitor or on a second monitor. As such, the system may detect when the gaze moves from a fixed point on the monitor to a point away from the monitor. In some implementations, a frequency and duration of closing of the operator's eyes may be analyzed in addition to or instead of gaze length.

In some implementations, to detect a fatigue level of an operator, the system may determine if the operator has stared at some fixed points for too long or closing their eyes often and for a long time, or the operator's gaze may get suspended. In other implementations, to detect a fatigue level of an operator, the system may detect that the operator has started frequently diverting his/her gaze from the workstation screen too often. The system may use a threshold value, such as a time value, as a reference point to compare the length of gaze of the operator to determine a fatigue level. The threshold value may be determined based upon analysis of data related to previous tasks completed by operators, or upon the length of gaze of the same operator in beginning of the work. In an implementation, the threshold value may be determined or adjusted by an administrator.

In some implementations, if the length of gaze of the operator is greater than the threshold value, the system may indicate that the operator is fatigued. For example, the operator may be assigned a task that requires the operator to frequently look at multiple points on a screen. If the operator is fatigued, the operator may stare at a fixed point on the screen for a prolonged time instead of performing the assigned task.

In other implementations, if the length of gaze of the operator is below the threshold value, the system may indicate that the operator is fatigued. The operator may be assigned a task that requires the operator to look at a fixed point on the screen for a prolonged time. When operators become fatigued they may frequently look away from the fixed point on the screen or close their eyes. The threshold value may be selected based upon the tasks being performed by the operator. Additionally, the system may use other metrics to monitor an activity level of an operator. In some implementations, the administrator may determine the metrics used to monitor the activity level of an operator based on collected data regarding completion of different tasks.

At block 220, cursor movements are recorded and analyzed. In some implementations, the speed at which the cursor moves and a time the cursor stays at one spot may be recorded. In an implementation, to determine the fatigue of the operator, multiple extended standstills of the cursor and/or reduction in the speed of the movement of the cursor around the screen may be tracked and recorded. For example, in one implementation, a mean rate of movement of the cursor around the screen may be calculated. In another implementation, the mean time the cursor stands still between operations done in regular mode may be calculated. If these parameters are exceeded, the system may determine that the operator is fatigued.

At block 230, frequency of key or touch inputs are recorded and analyzed. In some implementations, the frequency with which keys on the keyboard are pushed may be tracked and recorded or the frequency with which a touch screen is touched may be tracked and recorded. An increase in the interval between keystrokes and/or touches may indicate operator fatigue.

At block 240, a double check is performed. A check may refer to a task or operation sent an operator to be completed. In some implementations, a task or an operation that needs to be done may be assigned to two different operators for execution. Each operator may not suspect that there is another operator performing exactly the same operation. After each operator has performed the operation, their actions may be compared against one another. In an implementation, if their actions coincide, the operators are considered not fatigued. In some implementations, if there is some discrepancy or difference in the actions of the operators, a third check may be performed on this operation. The results of the third check may be compared to the results of the first two checks (i.e., the double check). In an implementation, the operator whose actions were less efficient than the other two checks may be considered fatigued. In some implementations, if the three actions turn out different, another method is used to check operator fatigue.

At block 250, a control double check is performed. In some implementations, the control double check may be used to perform additional monitoring of the activities of the operator to determine the quality of the operations they have performed and/or completed. The control double check may include comparing the actions of an operator to actions previously completed by the same operator. In other implementations, the control double check may include comparing the actions of an operator to a set of actions known to be correct. In an implementation, during the control double check, the operator may be prompted to perform and/or assigned operations on which clearly correct actions are known to exist. These operations may be referred to as control operations and/or controls tasks. The control operations may be selected from a set of control operations and/or a set of control tasks.

The control operations may include operations previously performed by the operator, operations performed by other operators, and/or a set of control operations created as a reference for verifying accuracy of performing operations. In an implementation, an operator may be assigned a control task. The control task completed by the operator may then be compared to a set of control tasks. A special feature of the control operations is that the operator performing them may not be aware that the result of the control operations is already known.

In some implementations, an operator may be assigned multiple control tasks. After the operator performs the assigned control tasks, the system compares the quantity of agreements between the correct actions and the operator's actions. In an implementation, a decision may be made about whether it is necessary to transfer to light-duty mode based on the number of mistakes made by the operator. For example, in verification tasks some documents to be verified may have no recognition errors and no correct actions are needed for such documents. To control the quality of operator's work, a control task with a known number of recognition mistakes should be used. For example, the control task may contain N incorrect recognized characters, the errors and correct variant for each error are known to the system. If an operator does not find 20% of the errors or correct them with mistakes, then the operator may be considered as fatigued. An administrator may adjust an acceptable percentage of operator's mistakes. A big quantity of mistakes may be characteristic of an inattentive person, so if the big quantity of mistakes is regular for the operator, the administrator can be notified about it.

In some implementations, the control double check can be used for data verification. For example, in one implementation, the operator dealing with the verification may be prompted to check the recognized data. The task of the operator will be to check the accuracy of recognition of the characters. For a control double check, the document with data previously known to be properly recognized may be used. In other words, an operator, without suspecting it, may perform operations for which the responses are already in the system's database. After the operator has performed the operations, there is a computation of the quantity of agreements between the correct responses and the operator's responses. In some implementations, if the discrepancy in the responses is insignificant or there is no discrepancy at all, the operator returns to working on regular operations (i.e., not control operations in regular mode). However, in other implementations, if the quantity of mistakes exceeds a specified number, percentage or a threshold value, the system may transfer the operator to light-duty mode. At any time, the statistics on the correct/incorrect responses of the operator performing control tasks or operations can be viewed by an administrator of the system.

Any one of the methods described above with respect to FIG. 2 can be used to determine a fatigue level of an operator. In some implementations, several of the methods described above may be used in combination and/or simultaneously, to determine a fatigue level of an operator. Additionally, the above methods may be used both for operators handling data verification and for operators handling any other activity that involves doing uniform operations. In some implementations other different methods of detecting the fatigue level may be used. For example, the frequency of self-correction of mistakes made by the operator may be tracked and recorded. In some implementations, the system may register the frequency of self-corrections of performed operations made by the operator, i.e. when the operator returns to already done items and corrects own answers or inputs. A decision may be made about how fatigued the operator is based on the frequency of self-corrections. In an implementation, the decision may be a function of how frequently the operator corrects already completed operations and/or tasks. If the operator, for example, corrects 10% of his/her answers or inputs, it may indicate the fatigue state. The threshold percentage of self-correction can be changed by administrator to another acceptable value. Sometimes frequent self-correction may be a character trait of person, so it is best to monitor a percentage of self-corrections in beginning of operator's work and then compare the monitored value with the value at the beginning of work. For example, if the percentage of self-corrections increases twice, then the operator is considered to be fatigue.

In some implementations, the methods to monitor the fatigue level of an operator and the variants for light-duty mode can be selected automatically. In other implementations, the methods to monitor the fatigue level of an operator and variants for light-duty mode can be adjusted by an administrator.

An operator performing monotonous work runs a rather strong risk of fatigue and loss of attention. To avoid mistakes made in a fatigued state, the operator may be offered simpler tasks. In some implementations, after it is detected that an operator is fatigued, the system can switch to light-duty mode. In light-duty mode the operator may be asked to perform tasks that are simpler than those performed in regular mode. Some examples of tasks to be performed by an operator in light-duty mode are illustrated in FIGS. 3-5.

FIG. 3 illustrates an example of a task to verify recognized characters in a document image (e.g. filled form/questionnaire). FIG. 3 includes a rectangle 30 with current position of verification, captured character images 32 to be recognized by a system, results of their character recognition 34, result of recognition for current verifying character 36, and its context location 38. In some implementations, the character image 38 may be a character in the context of a document. The characters to be recognized 32 may include, for example and without limitations, digits, symbols, and/or letters.

In some implementations, to verify recognized characters 34 in the document, light-duty mode may only involve the pressing of a single key. For example, in an implementation, a character image from captured character images 32, which is verifying by an operator at a current time can be highlighted and placed in a rectangle 30. By pressing a single key, the operator either verifies that the recognized character 36 (recognition result) is correct or revises it to the correct character. In some implementations, the correction is done by pressing a key on a keyboard that corresponds to the correct character. In other implementations, the correction is made by touching a touchscreen. The operator may also be given the capability of showing a verified character in the context of the document image 38, for example, if the operator has any doubts in verification of the recognition result 36. The operator may be able to compare the character in question with a context information (with word from which the character was taken, with question to a field where the character was input, etc.), or to compare to a similar character in the context of the document. The context information may be helpful to verify that the character in question is correct for example in case of cacography or bad handwriting.

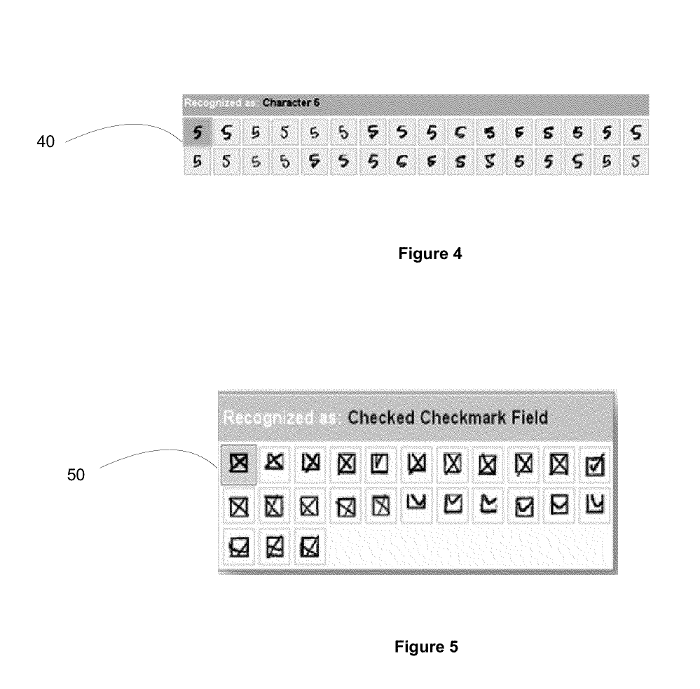

FIGS. 4 and 5 illustrate examples of group verification. In some implementations, light-duty mode may involve the capability to group similar items on which similar operations are to be performed. Items for which the operator performs the same operation will be structured together (e.g., as a group). In one implementation, for example and without limitation, the items grouped together can be depicted on the screen at the workstation. If the operator believes that some item has been mistakenly added to the group, he or she can remove them, in case of doubt the context from the document image may be requested to view for an unclear item. For example, all or part of character images recognized by a system as a same particular character can be grouped in a window as shown in FIG. 4, the operator may confirm the all the images show exactly the particular character or correct/remove mistaken images. As illustrated in FIG. 4, the items 40 being examined are all or part of the character images in a document (batch of documents) being verified that are recognized as the character “5.” If all of the images shown on the screen are actually digits “5”, the operator can agree with the results of recognition. If any of the characters were recognized incorrectly, meaning not actually a “5,” the operator may revise the result of recognition to the correct one and/or remove it from the list presented.

An operator performing monotonous work, even in light-duty mode, runs a rather strong risk of fatigue and loss of attention. To avoid mistakes made in a fatigued state, the operator may be offered even simpler tasks. For example, an even simpler task that can be suggested for an operator performing group verification of digits on blank forms, as illustrated in FIG. 4, is a group verification of checkmarks.

FIG. 5 illustrates an example of group verification of checkmarks. In some implementations, if the application at any time finds that the operator is fatigued, then after the work station is switched to light-duty mode, the operator may be offered the task of group verification of checkmark images on blank forms 50, which may be simpler than verifying digits or letters. As illustrated in FIG. 5, an operator may be tasked with verifying that a mark in a box is actually a checkmark, i.e. a mark in a box is not a noise or blot. The operator may be given a group of images of checkmark boxes and verify whether all, some, or none of them are actually valid checkmarks.

In some implementations, when an operator is transferred to light-duty mode, operations that are not included in light-duty mode can be transferred to another operator. The other operator may still be working in regular mode.

In some implementations, light-duty mode may include switching to a yes/no setting. In the yes/no setting, the operator may perform operations that only require yes or no responses. Such a yes/no setting may involve verification of recognized character images. In this implementation, an operator may be shown an image of a character and the most probable recognition variant of it. The operator can answer yes if the operator believes that the character has been correctly recognized. Further, the operator can select the no response if the operator believes the character has been incorrectly recognized, the operator also may correct this character. In some implementations, the operator may select a version of yes/set aside responses. In this implementation, if the response is yes, the operator agrees with the result of recognition. If the operator selects the set-aside response, the data presented for verification will appear again in regular mode or can be sent to a more qualified operator for verification.

In some implementations, during light-duty mode, only some operator responses may be considered. For example, the system, after detecting the operator is fatigued, may not accept and/or consider some responses from the operator. After the system transitions to regular mode, the operator will again be given operations for which the responses were not considered when the operator was operating in light-duty mode. For example, one might consider (accept) those operations for which the response was yes. In some implementations, for those which the response was no, the system may submit they be redone later in regular mode. In regular mode, the operator may be given characters for which a ‘no’ response was received during verification in light-duty mode.

In some implementations, the system may be configured to send notices to the operator. The notices may be sent responsive to a detection of a fatigue level in the operator. The notices may include, for example and without limitation, notices with a suggestion to rest, notices with a suggestion to take a few minutes break, notices to drink some tea or coffee, notices to change the work mode, or ask a question, etc. In some implementations, the notices may appear on a workstation computer screen of the operator.

In some implementations, the capabilities accessible in light-duty mode may be adjusted by the operator. In other implementations, the capabilities accessible in light-duty mode may be adjusted by an administrator. In one implementation, at any time, the operator may select any type of operations accessible in light-duty mode. In some implementations, when the system transitions from one mode to another mode, the operator may be shown a notification that the system is transitioning to the appropriate mode. In other implementations, the when the system transitions from one mode to another mode, the operator may not be shown a notification that the system is transitioning to a different mode. The system can store statistics on the operations performed, the number of mistakes made, the idle time between operations, and other parameters. At any time, the information on an operator's statistics can be shown. In some implementations, when the system registers that fatigue is gone it may return the operator in a regular mode.

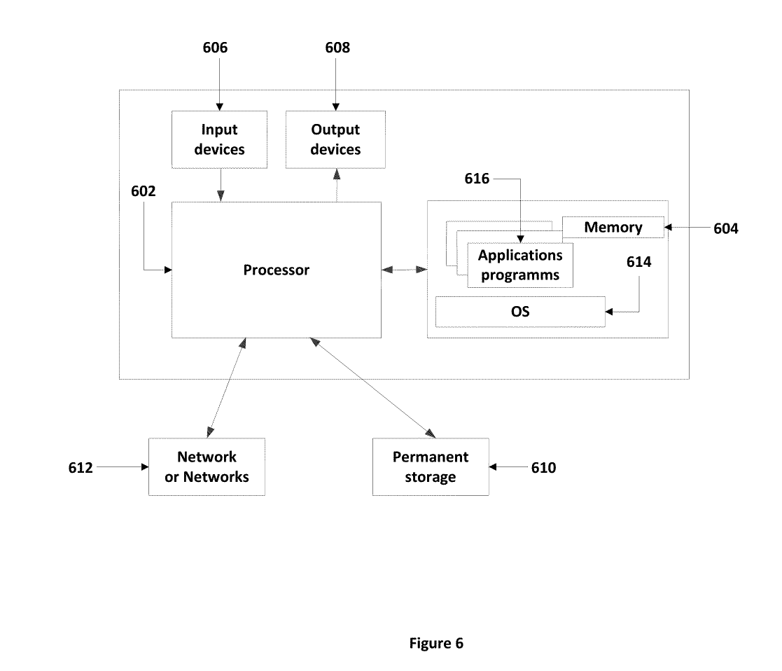

FIG. 6 illustrates an example of a system for detecting a fatigue level of an operator and assigning a mode of operating. In more detail, FIG. 6 illustrates an example of a computer platform 600 that may be part of an electronic device used to implement the methods accomplished as described above. In one implementation, the computer platform 600 is encoded on a computer-readable medium that contains instructions that, when executed by the computing device, cause an electronic device to perform operations described in FIGS. 1 and 2. The computer platform 600 includes at least one processor 602 connected to a memory 604. The processor 602 may be one or more processors, may contain one, two, or more computer cores, or may be a chip or other device capable of doing computation (for example, a Laplace transform may be performed optically). The memory 604 may be a random-access memory (RAM) and may also contain any other types or kinds of memory, particularly non-volatile memory devices (such as flash drives) or permanent storage devices such as hard drives, etc. In addition, an arrangement can be considered in which memory 604 includes information-storage media built into equipment physically located elsewhere on the computer platform 600, such as a memory cache in the processor 602 used as virtual memory and stored on an external or internal permanent storage device 610.

The computer platform 600 can have a certain number of input and output ports to transfer information out and receive information. For example and without limitation, for interaction with a user, the computer platform 600 may include one or more input devices (such as a keyboard, a mouse, a scanner, etc.) and a display device 608 (such as a liquid crystal display or special indicators). In some implementations, a camera (not shown) may be coupled to the system. In an implementation, the camera may be communicatively coupled to the system to transmit images and data to the computer platform 600, for example and without limitation, via a wireless connection. In other implementations, the camera may be directly coupled to the computer platform 600 as part of the same system.

The computer platform 600 may also have one or more read only memory devices 610 such as an optical disk drive (CD, DVD or other), a hard disk, or a tape drive. In addition, the computer platform 600 may have an interface with one or more networks 612 that provide connections with other networks and computer equipment. In particular, this may be a local area network (LAN) and/or a wireless Wi-Fi network, which may or may not be connected to the World Wide Web (Internet). It is understood that the computer platform 600 includes appropriate analog and/or digital interfaces between the processor 602 and each of the components (604, 606, 608, 610 and 612).

In some implementations, the computer platform 600 is managed by the operating system 614 and includes various peripherals, components, programs, objects, modules, etc. designated by the consolidated number 616.

This description shows the basic inventive concept of the inventors, which is not to be limited by the hardware discussed herein. As time goes by and as technology develops, the hardware used to implement the subject matter described herein may change. New tools arise that are capable of meeting new demands. In this sense, it is appropriate to look at this hardware from the point of view of the class of technical tasks it can solve, not simply a technical implementation on some set of hardware components.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the disclosure. Moreover, while the disclosure has been described in the context of fully functioning computers and computer systems, those skilled in the art will appreciate that the various embodiments of the disclosure are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present disclosure has been described with reference to specific exemplary embodiments, it will be evident that the various modification and changes can be made to these embodiments without departing from the broader spirit of the disclosure. Accordingly, the specification and drawings are to be regarded in an illustrative sense rather than in a restrictive sense.

While certain exemplary embodiments have been described and shown in the accompanying drawings, it is to be understood that such embodiments are merely illustrative and not restrictive of the broad disclosure and that this disclosure is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method for detecting a fatigue level of an operator, the method comprising:
monitoring an activity level of an operator in a first mode;
detecting a change in the activity level of the operator in the first mode; and
switching to a second mode from the first mode, in response to detecting the change in the activity level of the operator.

2. The method of claim 1, wherein monitoring the activity level further comprises:
monitoring a parameter of the activity level during a time period in the beginning of the operator's work;
calculating a mean value of the parameter for the time period;
determining a threshold value based at least in part on the mean parameter value; and
comparing new values of the monitored parameter with the threshold value.

3. The method of claim 1, wherein monitoring the activity level further comprises monitoring eye movement of the operator.

4. The method of claim 3, wherein monitoring the eye movement of the operator further comprises:
recording a length of gaze on fixed points during a time period;
calculating an average length of gaze for the time period; and
comparing the average length of gaze on fixed points to a threshold value.

5. The method of claim 1, wherein monitoring the activity level further comprises tracking a frequency of keystrokes or touch inputs.

6. The method of claim 1, wherein detecting the change further comprises:
calculating a mean rate for a cursor;
recording a speed of the cursor controlled by the operator; and
comparing the speed of the cursor to the mean rate.

7. The method of claim 1, wherein detecting the change further comprises:
calculating a mean time for the cursor remaining still;
determining an amount of time the cursor remains still; and
comparing the amount of time the cursor remains still to the mean time.

8. The method of claim 1, wherein detecting the change further comprises recording a number of self-corrections made by the operator.

9. The method of claim 1, wherein detecting the change further comprises:
assigning a first task to the operator;
assigning a second task to a second operator; and
comparing the first task completed by the operator to the second task completed by the second operator.

10. The method of claim 1, wherein detecting the change further comprises
assigning a control task to the operator; and
comparing the completed control task to a correct version of performing the control task.

11. The method of claim 1, wherein switching to the second mode comprises switching to a mode with easier tasks for the operator.

12. A system to detect a fatigue level of an operator, the system comprising:
a memory configured to store processor-executable instructions; and
a processor operatively coupled to the memory, wherein the processor is configured to:
monitor an activity level of an operator in a first mode;
detect a change in the activity level of the operator in the first mode; and
switch to a second mode from the first mode, in response to detecting the change in the activity level of the operator.

13. The system of claim 12, further comprising a camera.

14. The system of claim 12, wherein the processor is further configured to:
monitor a parameter of the activity level during a time period in the beginning of the operator's work;
calculate a mean value of the parameter for the time period;
determine a threshold value based at least in part on the mean parameter value; and
compare new values of the monitored parameter with the threshold value.

15. The system of claim 12, wherein the processor is further configured to monitor eye movement of the first operator.

16. The system of claim 15, wherein the processor is further configured to:
record a length of gaze on fixed points during a time period;
calculate an average length of gaze for the time period; and
compare the average length of gaze on the fixed points to a threshold value.

17. The system of claim 12, wherein the processor is further configured to track a frequency of keystrokes or touch inputs.

18. The system of claim 12, wherein the processor is further configured to:
calculate a mean rate for a cursor;
record a speed of the cursor controlled by the operator; and
compare the speed of the cursor to the mean rate.

19. The system of claim 12, wherein the processor is further configured to:
calculate a mean time for the cursor remaining still;
determine an amount of time the cursor remains still; and
compare the amount of time the cursor remains still to the mean time.

20. The system of claim 12, wherein the processor is further configured to record a number of self-corrections made by the operator.

21. The system of claim 12, wherein the processor is further configured to:
assign a first task to the operator;
assign a second task to a second operator; and
compare the first task completed by the operator to the second task completed by the second operator.

22. The system of claim 12, wherein the processor is further configured to:
assign a control task to the first operator; and
compare the completed control task to a correct version of performing the control task.

23. The system of claim 12, wherein the processor is further configured to switch to a mode with easier tasks for the operator.

24. A non-transitory computer-readable storage medium having computer-readable instructions stored therein, the instructions being executable by a processor of a computing system, wherein the instructions comprise:
instructions to monitor an activity level of an operator in a first mode;
instructions to detect a change in the activity level of the operator in the first mode; and
instructions to switch to a second mode from the first mode, in response to detecting the change in the activity level of the operator.

25. The non-transitory computer-readable storage medium of claim 24, further comprising:
instructions to monitor a parameter of the activity level during a time period in the beginning of the operator's work;
instructions to calculate a mean value of the parameter for the time period;
instructions to determine a threshold value based at least in part on the mean parameter value; and
instructions to compare new values of the monitored parameter with the threshold value.

26. The non-transitory computer-readable storage medium of claim 24, further comprising instructions to monitor eye movement of the first operator.

27. The non-transitory computer-readable storage medium of claim 26, further comprising:
instructions to record a length of gaze on fixed points during a time period;
instructions to calculate an average length of gaze for the time period; and
instructions to compare the average length of gaze on fixed points to a threshold value.

28. The non-transitory computer-readable storage medium of claim 24, further comprising instructions to track a frequency of keystrokes or touch inputs.

29. The non-transitory computer-readable storage medium of claim 24, further comprising:
instructions to calculate a mean rate for a cursor;
instructions to record a speed of the cursor controlled by the first operator; and
instructions to compare the speed of the cursor to the mean rate.

30. The non-transitory computer-readable storage medium of claim 24, further comprising:
instructions to calculate a mean time for the cursor remaining still;
instructions to determine an amount of time the cursor remains still; and
instructions to compare the amount of time the cursor remains still to the mean time.

31. The non-transitory computer-readable storage medium of claim 24, further comprising instructions to record a number of self-corrections made by the operator.

32. The non-transitory computer-readable storage medium of claim 24, further comprising:
instructions to assign a first task to the operator;
instructions to assign a second task to a second operator; and
instructions to compare the first task completed by the operator to the second task completed by the second operator.

33. The non-transitory computer-readable storage medium of claim 24, further comprising:
instructions to assign a control task to the operator; and
instructions to compare the completed control task to a correct version of performing the control task.

34. The non-transitory computer-readable storage medium of claim 24, further comprising instructions to switch to a mode with easier tasks for the operator.
